(19) United States
(12) Patent Application Publication
(10) Pub. No.: US 2011/0061953 A1
(43) Pub. Date: Mar. 17, 2011

(54) FLYWHEEL ENERGY STORAGE SYSTEM

(76) Inventors: Charles Gibson, Hackettstown, NJ (US); Dolleva Rogers, Brooklyn, NY (US)

(21) Appl. No.: 12/559,689

(22) Filed: Sep. 15, 2009

(51) Int. Cl. B60K 6/30

(52) U.S. Cl. 180/65.6; 180/65.21

(57) ABSTRACT

A flywheel energy storage system for a vehicle, comprising a first shaft, a second shaft operatively coupled to the first shaft and to the vehicle's drivetrain, a flywheel operatively coupled to the first shaft, and a motor operatively coupled to the first shaft and electrically coupled to a power source, the motor being adapted to receive energy from the vehicle's electrical system and the flywheel energy storage system being adapted to transfer energy to the vehicle's drive system.

### BACKGROUND

The shrinking supply and rising cost of automobile fuel has stimulated development of technologies for increasing the fuel efficiency of motor vehicles. Such development has not only led to highly efficient internal combustion engines, but also to hybrid-drive vehicles that are powered by an electric motor at low speeds. In such vehicles, the electric motor is powered by a battery pack, while an internal combustion engine assists the electric motor when the vehicle encounters heavy load situations such as fast acceleration, high speed or hill climbing, or when the charge is depleted. The battery pack in such vehicles may be recharged by the internal combustion engine, or by energy recovery methods such as regenerative braking.

Other automotive technologies designed to maximize fuel efficiency include electric-drive cars, wherein an electric motor directly drives the vehicle using energy from a battery pack, while an internal combustion engine may power a generator that provides energy to the electric motor when the battery pack is depleted. In such cars, the battery pack may be recharged using an external charging station, or by energy recovery methods such as regenerative braking.

While advances in battery technology have led to more efficient, durable, and higher-capacity energy storage cells, inefficiencies are still inherent in converting mechanical energy into chemical energy for battery storage, and vice versa. Furthermore, electric motors are ill suited for driving situations having high or varying power loads. A means for storing energy while minimizing energy loss and providing rapid response to high-load situations is therefore needed.

### SUMMARY

According to at least one exemplary embodiment, a flywheel energy storage system is disclosed. The flywheel energy storage system may include an electric motor, a flywheel, a flywheel shaft, and a crankshaft. The electric motor and flywheel shaft, as well as the flywheel shaft and crankshaft may be coupled via gearsets. The crankshaft of the flywheel energy storage system may be coupled to the drivetrain of the vehicle. In operation, the flywheel energy storage system may store energy, providing it as necessary to the vehicle's drivetrain under certain conditions, for example, under rapid acceleration. The system may also recover energy from the drivetrain under certain conditions, for example, during regenerative braking. The flywheel energy storage system may thus serve to minimize energy loss and optimize power output in gasoline-powered, hybrid, and electric vehicles.

### BRIEF DESCRIPTION OF THE DRAWINGS

FIG. 1 is an exemplary diagram of a flywheel energy storage system.

FIG. 2 is an exemplary diagram of a vehicle including a flywheel energy storage system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

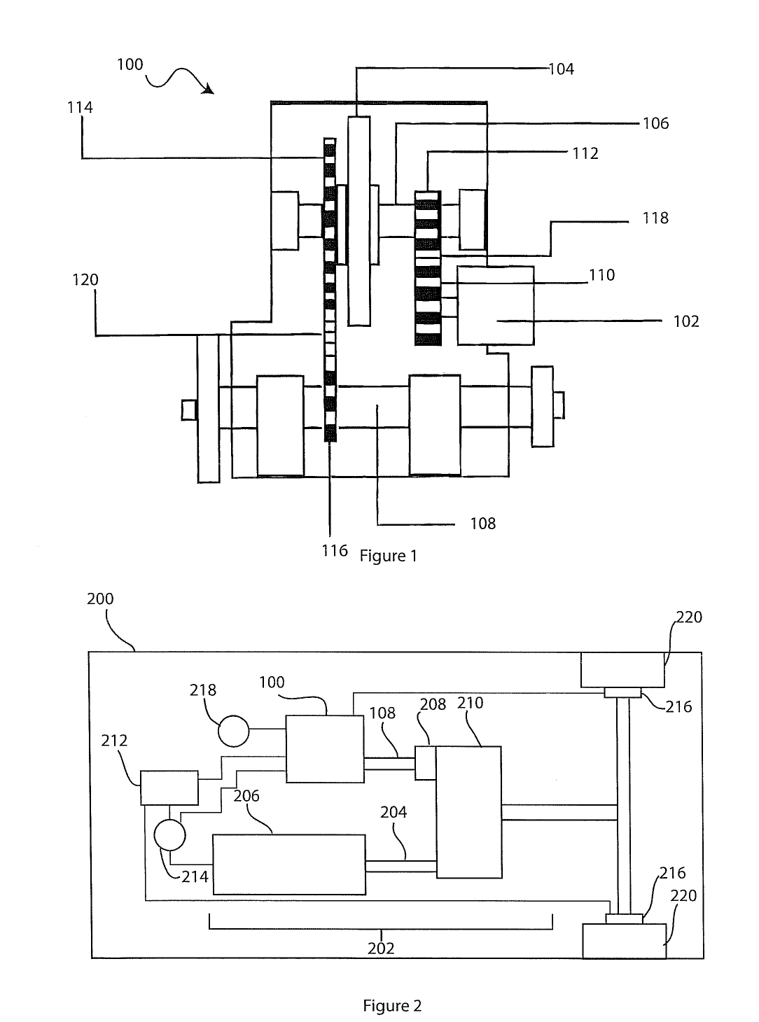

Turning to FIG. 1, in one exemplary embodiment, a flywheel energy storage system 100 is provided. System 100 may include electric motor 102, flywheel 104 coupled to flywheel shaft 106, and crankshaft 108. Electric motor 102 may include driving gear 110 coupled thereto. Also coupled to flywheel shaft 106 may be input gear 112 and output gear 114. Crankshaft 108 may have crankshaft gear 116 coupled thereto. Driving gear 110 and input gear 112 may be coupled via a first chain 118 while output gear 114 and crankshaft gear 116 may be coupled via a second chain 120. In one embodiment, driving gear 110 may be coupled directly to input gear 112, and output gear 114 may be coupled directly to crankshaft gear 116.

Driving gear 110 and input gear 112 may be sized such that driving gear 110 is larger than input gear 112. In one embodiment, the amount of gear teeth on driving gear 110 and the amount of gear teeth on input gear 112 may be related in a 2:1 ratio. For example, driving gear 110 may have 40 gear teeth, while input gear 112 may have 20 gear teeth. Output gear 114 and crankshaft gear 116 may be sized such that output gear 114 is larger than crankshaft gear 116. In one embodiment, the amount of gear teeth on output gear 114 and the amount of gear teeth on crankshaft gear 116 may be related in a 2.52:1 ratio. For example, output gear 114 may have 48 gear teeth, while crankshaft gear 116 may have 19 gear teeth. Consequently, every complete revolution of driving gear 110 may result in 5.04 revolutions of crankshaft 108. Therefore, for example, to spin crankshaft 108 at 750 revolutions per minute, electric motor 102 may spin at 149 revolutions per minute. The above-described ratios may therefore reduce energy consumption by electric motor 102.

In one exemplary embodiment, flywheel 104 may have a diameter approximately within the range of 10 to 12 inches, and a weight approximately within the range of 10 to 75 pounds. By varying these parameters, a desired angular moment of inertia for flywheel 104 may be achieved. The operating parameters of electric motor 102 may also be varied as desired; for example, in one embodiment, electric motor 102 may generate horsepower approximately within the range of 0.33 horsepower to over 2.25 horsepower. Motor 102 may also have a maximum revolutions-per-minute limit approximately within the range of 1800 rpm to 5500 rpm.

In one exemplary embodiment, the coupling between input gear 112 and flywheel shaft 106 may be a one-way overrunning-type clutch. Consequently, when the rotational speed of flywheel 104 and flywheel shaft 106 is greater than the rotational speed of motor 102 and driving gear 110, damage to motor 102 may be avoided. In another exemplary embodiment, flywheel 104 may be coupled to flywheel shaft 106 via a clutch that may be engaged when transmission of power to or from the flywheel is desired. As a result, energy loss due to friction between the components of flywheel energy storage system 100 may be minimized. In another exemplary embodiment, flywheel 104 may reside within a vacuum chamber to further minimize energy loss due to air resistance between flywheel 104 and the environment.

Turning to FIG. 2, flywheel energy storage system 100 may then be coupled to drive system 202 of vehicle 200. In one embodiment, flywheel energy storage system 100 may be coupled to drive system 202 of the vehicle in a linear fashion. For example, crankshaft 108 may be coupled to the driveshaft 204 of engine 206. Engine 206 may be an internal combustion engine, an electric motor, or a hybrid drive system. Coupling 208 between crankshaft 108 and engine 202 may include a friction plate clutch-type apparatus, a fluid coupling such as a torque converter, or any other coupling known to one having ordinary skill in the art. Additionally, coupling 208 may include transmission 210, which may be a standard manual transmission, a planetary-gear automatic transmission, a continuously variable transmission, or any other power transmission system known to one having ordinary skill in the all. In one embodiment, transmission system 210 may manage the proportion of power transferred to drive system 202 of vehicle 200 by flywheel energy storage system 100. Flywheel energy storage system 100 may also be operatively coupled to chemical energy storage system 212, which may consist of any battery technology known to one having ordinary skill in the art. Additionally, chemical energy storage system 212 may be recharged by alternator 214 or regenerative braking system 216.

In operation, motor 102 may spool up flywheel 104 such that the rotational speed of flywheel 104 is within a desired speed range. For example, electric motor 102 may operate at approximately 500 rpm, which may translate to flywheel 104 rotating at approximately 1000 rpm, may result in crankshaft 108 rotating at approximately 2,520 rpm. At this rate, vehicle 200 may be traveling at approximately 70 mph, depending on the final drive ratios of the vehicle. In one embodiment, motor 102 may be powered by electrical current from battery system 212. Motor 102 may also be powered by electrical current generated by alternator 214 or regenerative braking system 216. Powering the motor directly from alternator 214 or regenerative braking system 216 presents an advantage as it may avoid the energy loss and detriment to battery health inherently present when the battery is subjected to charge and discharge cycles. In another embodiment, motor 102 may include a turbine 218 for partially or completely facilitating the rotation of motor 102. Turbine 218 of motor 102 may be powered by compressed air generated by a belt-driven impeller or the like. Turbine 218 may be coupled to motor 102 via a gearset designed to maximize power transferred to motor 102.

Once flywheel 104 is rotating at the desired rotational speed, flywheel energy storage system 100 may be engaged, via transmission 210 or other coupling 208, to transmit power to drive wheels 220 of vehicle 202. Engagement may be facilitated at driver request or via an engine-management computer or the like. For example, in a hybrid or electric-powered vehicle, flywheel 104 may be engaged when there is a sudden demand for increased power. Flywheel 104 thereby assists the electric engine in propelling vehicle 200 and minimizes peak power loads on the electric engine and facilitating efficient operation of the electric engine. In another embodiment, system 100 may be engaged to assist a vehicle's internal combustion engine, providing additional power to the drive system while facilitating keeping the internal combustion engine at an efficient operating speed.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A flywheel energy storage system for a vehicle, comprising:
a first shaft;
a second shaft operatively coupled to the first shaft and to the vehicle's drivetrain;
a flywheel operatively coupled to the first shaft; and
a motor operatively coupled to the first shaft and electrically coupled to a power source;
wherein the motor is adapted to receive energy from the vehicle's electrical system; and
wherein the flywheel energy storage system is adapted to transfer energy to the vehicle's drive system.

2. The flywheel energy storage system of claim 1, wherein the electric motor and first shaft are operatively coupled via a first gear and a second gear.

3. The flywheel energy storage system of claim 2, wherein the first gear and the second gear are coupled to each other via a chain.

4. The flywheel energy storage system of claim 2, wherein the gear ratio of the first gear to the second gear are related is 2:1.

5. The flywheel energy storage system of claim 1, wherein the first shaft and second shaft are operatively coupled via a third gear and a fourth gear.

6. The flywheel energy storage system of claim 5, wherein the first gear and the second gear are coupled to each other via a chain.

7. The flywheel energy storage system of claim 5, wherein the gear ratio of the third gear to the fourth gear are related is 2.52:1.

8. The flywheel energy storage system of claim 1, wherein the motor is further adapted to receive energy from a source of compressed air.

9. The flywheel energy storage system of claim 8, wherein the motor is operatively coupled to a turbine.
